(19) United States
(12) Patent Application Publication
(10) Pub. No.: US 2009/0240578 A1
(43) Pub. Date: Sep. 24, 2009

(54) METHODS AND SYSTEMS FOR GRAPHICAL SECURITY AUTHENTICATION AND ADVERTISING

(76) Inventors: Christopher James Lee, Tulsa, OK (US); James Luke Sontag, Claremore, OK (US); Scott A. Blomquist, Tulsa, OK (US); Steven L. Osborn, Sand Springs, OK (US); Benjamin Joel Stover, Tulsa, OK (US); Joel Norvell, Tulsa, OK (US); Nicholas A. Davis, Tulsa, OK (US)

Correspondence Address: WILSON SONSINI GOODRICH & ROSATI, 650 PAGE MILL ROAD, PALO ALTO, CA, 94304-1050, US

(21) Appl. No.: 12/050,885

(22) Filed: Mar. 18, 2008

(51) Int. Cl. G06Q 30/00; G06F 15/16

(52) U.S. Cl. 705/14

(57) ABSTRACT

The present invention is directed to a graphical image identity authentication system. In particular, the invention is directed to methods and systems for graphical security authentication and advertising. A security authentication system may receive advertisements from an advertising service company, process the advertisements to integrate them into the graphical image identity authentication system, and transmit the processed advertisement information back to the advertisement service company. The security authentication system may also monitor user interaction with the advertisements and transmit the logged information to the advertising service company.

### BACKGROUND OF THE INVENTION

1. Field of the Invention

The present invention is directed to a method and system of authenticating identity to a computer system. In particular, the present invention provides methods and systems for graphical security authentication and advertising. A security authentication system may receive advertisements from an advertising service company, process the advertisements to integrate them into a graphical image identity authentication system, and transmit the processed advertisement information back to the advertisement service company.

2. Background

Computer networks, particularly those with global reach such as the Internet, have greatly influenced the way that individuals, companies and institutions conduct transactions, and store and retrieve documents, images, music, and video. Convenience, ease of use, speed, and low overhead costs are contributing factors to the widespread use of the Internet for purchasing goods as well as conducting confidential transactions. Entire industries have emerged as a result of the evolution of the Internet.

Secure access to computer systems and computer networks has been traditionally guarded with a username and password pair. This requires the user to protect the username and password from unauthorized use. If the username and password are not protected, accounts and files can be compromised.

U.S. Patent Application Publication No. 2004/0230843 to Jansen, which is incorporated by reference herein, discloses a login authentication process using a sequence of images selected by the user, illustrates the potential of image-based authentication in protecting users from identity theft. The authentication method described in this patent application begins with the user selecting an image theme, such as animals, and then selecting a sequence of images within the image theme that becomes the password (e.g. if the category chosen is animals, one possible sequence is horse, cat, dog, cat, cat, horse). The success of the login process is predicated on the user's ability to replicate the sequence of images he or she has chosen within the image theme. In other words, the user must memorize the proper sequence.

The distribution of advertising with graphical images via computers is well established. As the number of people using the Internet has exploded, advertisers have come to appreciate media and services offered over the Internet as a powerful way to advertise. Advertisers have developed several strategies in an attempt to maximize the value of such advertising. In one strategy, advertisers use websites as conduits to reach a large audience. In another strategy, an advertiser may attempt to target its advertisements to more narrow niche audiences, thereby increasing the likelihood of a positive response by the audience. Advertisement managers may assist with coordinating and placing an advertisement in a variety of media environments to maximize advertisement value.

However, despite strategic placement of many advertisements, a user may choose to not pay attention to the advertisements, choosing to focus instead on the content of a website. Even when a user is forced to look at an advertisement, such as a pop-up, users may choose to close the advertisements without paying much attention to their content, in order to access the website content. Although targeted advertising may assist with advertising success, it is difficult to ensure that a user is actively paying attention to advertising content.

Because of these noted shortcomings, an improved system and method is needed for effective online advertising, directed to users during an authentication process.

### SUMMARY OF THE INVENTION

The present invention provides systems and methods for integrating a secure authentication system and advertisements. Various aspects of the invention described herein may be applied to any of the particular applications set forth below. The invention may be applied as a standalone authentication system or also as a revenue generating advertising component to an integrated authentication solution. The invention can be optionally integrated into existing business and authentication processes seamlessly. It shall be understood that different aspects of the invention can be appreciated individually, collectively or in combination with each other.

A preferable embodiment of the present invention enables interaction between an authentication and advertisement system and an advertising service company. In one implementation of sponsored authentication, an advertising service company may receive advertisements from one or more sources, and may transmit the advertisements to a security authentication system. The security authentication system may process the advertisements and may create a predetermined arrangement of one or more advertisements, which may be used in an authentication process. One example of a predetermined arrangement of advertisements may be a graphical authentication image grid. The security authentication system may transmit the processed advertisement content back to the advertising service company, which may display the predetermined arrangement of advertisements to a user. Depending on how the security authentication system is used, the arrangement of advertisements may be used to authenticate the user or to authenticate a website the user may be accessing.

Another aspect of the present invention provides authentication and advertisement systems that may log any user interactions with the advertisements, such as how often particular advertisements are displayed, whether a user places a mouse pointer over an advertisement, or whether the user clicks on the advertisement to receive further information, and may transmit this information to the advertising service company. Such logged information may be useful to the advertising service company to determine the effectiveness of particular advertisements or to provide a form of feedback that may assist in further development of advertisement campaigns.

Preferable embodiments of the invention may be extended by replacing or augmenting the images in the image grid with audio, video, or other forms of media or multimedia. This aspect of the present invention provides a number of other preferable embodiments or models as set forth in further detail herein.

Secured systems such as the ones described herein and others can be guarded against fraud and theft by implementing dynamic graphical advertisement and authentication systems. Because password elements within a graphical image arrangement preferably change in between sessions or transactions, there is no imminent breach of or loss of security even if a perpetrator observes entry of the actual password sequence. Someone observing entry of the password elements by the user cannot readily determine the relevant authenticating category or logic behind the password based on observation of the key entries alone since the locations and selection of the graphical images or icons are preferably randomized. Moreover, the selection of displayed graphical advertisement images, their positioning within an arrangement or grid, and their corresponding password elements, are preferably varied between authentication processes. The user does not have to memorize exact password characters but can rather look for graphical advertisement images falling within a selected authenticating category and enter in corresponding password elements as to those images only. Accordingly, various types of the over-the-shoulder attacks can be defended against by applying these and other concepts of the invention.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments.

FIG. 1 illustrates a method for advertising through a security authentication system.

FIG. 2 illustrates a method for advertising through a security authentication system that includes interacting with a user.

FIG. 3 illustrates a security authentication system with an advertising component and a security component.

### DETAILED DESCRIPTION OF THE INVENTION

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

The present invention provides a method and system for user identity authentication to a computer system which requires users to select an authentication sequence based on categories during enrollment and recreating the authentication sequence during login by graphically discerning images belonging to the previously selected categories.

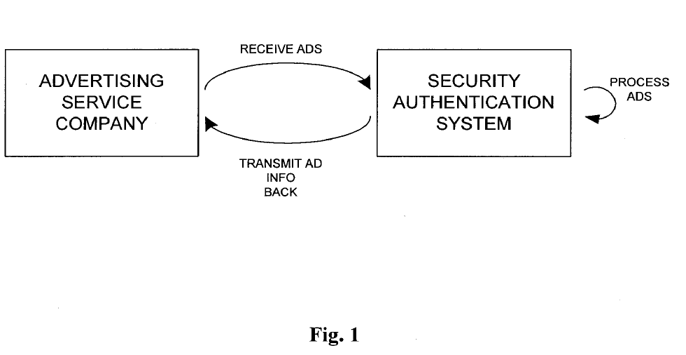

In accordance with one aspect of the invention, FIG. 1 illustrates systems and methods for sponsored authentication, in which advertising may occur through a security authentication system. An advertising service company may communicate with a security authentication system. The advertising service company may transmit advertisement images to the security authentication system. The security authentication system may process the advertisement images and may transmit the processed advertisement information back to the advertising service company.

In a preferable embodiment of the invention, an advertising service company may be a company that can utilize the security authentication system. For instance, an advertising service company may be a web portal, or any sort of website where a user needs to be authenticated or where a user may want to authenticate the website as being genuine. In one embodiment of the invention, security authentication systems and methods may be utilized as illustrated in pending patent application publication number 2007/0277224 filed Feb. 21, 2007, which is incorporated by reference herein. For example, an advertising service company may use the security authentication system to create a predetermined arrangement of one or more advertisement images, such as a graphical authentication image grid, as one step of an authentication process for a user to log onto the portal. In another embodiment, a security authentication system may create an arrangement of advertisements as one step of an authentication process to authenticate a website that a user may be accessing.

The advertising service company may possess advertisement images to be incorporated into the arrangement of one or more advertisements. The advertising service company may receive the advertisement images from one or more source. For example, a web portal may receive advertisements from different vendors, and may choose to incorporate them into the authentication process. In order to incorporate the advertisements, the advertising service company may transmit the advertisement images to the security authentication system.

After receiving the advertisement images, the security authentication system may process the advertisement images for use in the authentication process. The security authentication system may integrate the advertisement images into an arrangement of one or more advertisements. In one embodiment of the invention, the advertisement images may be assigned categories, which can be used for authentication. As mentioned previously, a user may select an authenticating category during enrollment. An advertisement may be assigned more than one applicable category. For instance, an authenticating category can be an item in the advertisement or a characteristic of the item. In one example, an advertisement showing a red Ford Mustang could be categorized as an automobile or as an object that is red. The categories assigned to each of the advertisement images may be determined by a variety of sources, including the advertising service company that may provide the advertisements, or the security authentication system that may process the advertisements. Additionally, the security authentication system may create a predetermined arrangement of advertisements, such as an image grid. Advertisement images may be selected for display in the arrangement of advertisements based on specifications from the advertising service company, an advertisement campaign, or other parameters.

The processed advertisement information, including the arrangement of advertisements and any relevant information such as authenticating or non-authenticating categories of the displayed advertisements, may be transmitted back to the advertising service company for use in the actual authentication process.

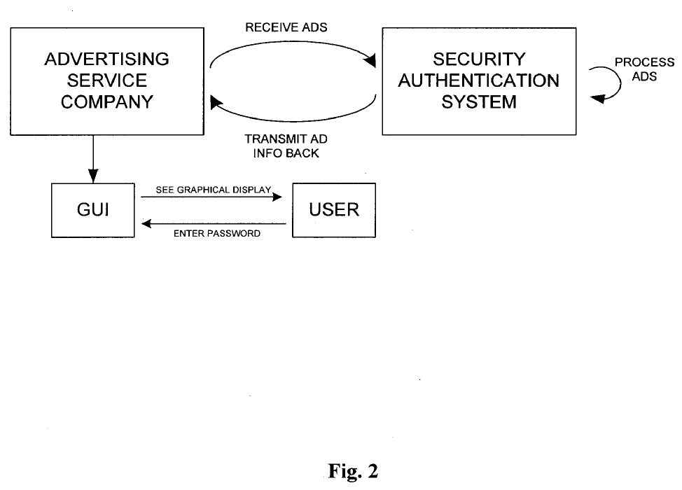

As shown in FIG. 2, a method for advertising through a security authentication system may include interacting with a user. In one embodiment, an advertising service company may communicate with a security authentication system. The advertising service company may also implement a graphical user interface. A user of the advertising service company may interact with it through the graphical user interface.

As mentioned previously, the advertising service company may communicate with the security authentication system to integrate the advertisement images into the security authentication system. In one embodiment, the security authentication system may receive advertisement images from the advertising service company. Similarly, it may process the advertisements and transmit the processed advertisement information back to the advertising service company.

The security authentication system may also create a predetermined arrangement of one or more advertisement images. In one embodiment of the invention, the arrangement of advertisements may be a graphical authentication image grid comprised of the advertisement images of both authenticating and non-authenticating categories. The arrangement of advertisements may be transmitted back to the advertising service company, which could then display it to a user via a graphical user interface. Authentication may occur as a user may interact with the arrangement of advertisements. In one embodiment of the invention, authentication of a user may occur when a user may see the graphical authentication image grid and may enter authentication information. For instance, the user can select an advertisement image on the image grid according to predetermined authenticating categories by entering a password element that corresponds to the advertisement image. In another embodiment, authentication of a website that a user may be accessing may occur when the user may see an arrangement of advertisements that corresponds in some predetermined manner, such as a predetermined category.

In a preferable embodiment of the invention, user interaction with the advertisements may be logged by the security authentication system. For example, the security authentication system may log which advertisement images were displayed to a user in an arrangement of advertisements, or may log whether the user selected an advertisement. A user may select an advertisement by placing a mouse pointer over a particular advertisement image to view additional information about the advertisement or to view an advertisement link, or by clicking on an advertisement link to open and view a new window with the advertising company's website. Such user interaction with the advertisements may be logged and transmitted back to the advertising service company. This information may be useful to the advertising service company to determine the effectiveness of particular advertisements and provide feedback to help further develop advertisement campaigns.

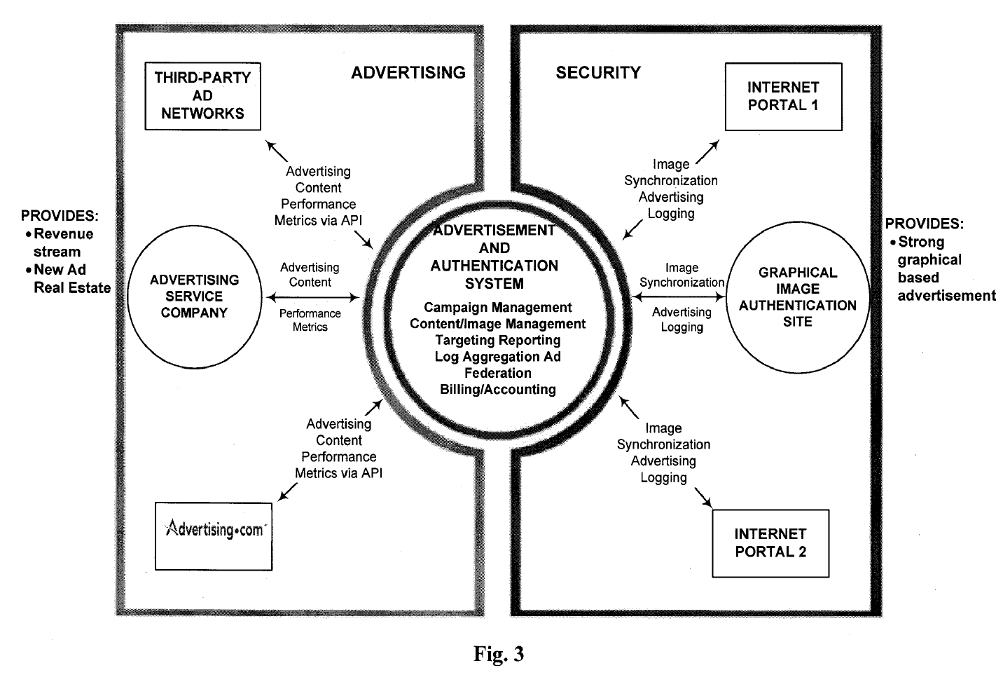

FIG. 3 illustrates a security authentication system provided in accordance with a preferable embodiment of the invention. The security authentication system may function as an advertisement and authentication system and may have an advertising component and a security component.

In the advertising component, the advertisement and authentication system may deal with advertisement image content, as well as any performance metrics of the advertisements. Advertisement image content may include the advertisement images, any categories that an advertising service company may have already associated with the advertisements, and any other relevant advertisement information. For example, an advertisement campaign may be in effect that could designate some advertisements to be displayed more frequently than others, or to be coupled with other advertisements or other categories of advertisements. Advertisements may also be directed to particular users with specific characteristics, given their enrollment information.

Performance metrics for advertisements may include a quantitative or periodic assessment of information about the advertisements displayed, including information about how often particular advertisements are displayed, whether a user puts a mouse pointer over a particular advertisement, or whether a user clicks on an advertisement to open a new window with the advertising company's website. Performance metrics may also include interpretations of the information in light of previous or comparable assessments. They may provide a form of feedback on current advertising parameters. The advertisement and authentication system may log this information during the security component of the system, and may assess and interpret the information in the advertising component.

In its security component, the advertisement and authentication system may deal with image synchronization and advertising logging. Image synchronization may include generating a predetermined arrangement of one or more advertisement images which may be used in an authentication process. In one embodiment of the invention, the arrangement of advertisements may include a graphical authentication image grid with both authenticating and non-authenticating categories. This image grid may be used to authenticate a user as previously discussed in pending patent application publication number 2007/0277224 filed Feb. 21, 2007, which is incorporated by reference herein.

Advertising logging may include keeping track of a user's activities in relation to various advertisements. This may include, but is not limited to, information about how often particular advertisements are displayed, whether a user places a mouse pointer over a particular advertisement, or whether a user clicks on an advertisement to open a new window with the advertising company's website. While the authentication of a user's identity is occurring, the system may automatically log user interactions with the advertisements. This information may be processed and transmitted in the advertising component of the security authentication system.

In between both the advertising and security components of the security authentication system, the system may perform various functions to implement both components. For example, the security authentication system may manage information relating to both an advertisement campaign and stored advertising content. The system may assist with advertisement targeting and reporting information about advertisements. This system may also keep track of billing and accounting, which may include charging for security services and for advertisements used in the authentication process.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. These are described as examples in relation to the drawings attached hereto and further modifications, apart from those shown or suggested herein, may be made within the spirit and scope of the invention. Furthermore, it shall be understood that all aspects of the invention are not limited to the specific configurations set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for advertising through a security authentication system, the method comprising:
receiving a plurality of advertisement images from an advertising service company; and
integrating the plurality of advertisement images into a security authentication system having a dynamic graphical arrangement of advertisement images.

2. The method of claim 1 further comprising receiving and logging advertisement activity.

3. The method of claim 2 further comprising transmitting logged advertisement information back to the advertising service company.

4. The method of claim 1 wherein the dynamic graphical arrangement of the advertisement images has: at least one advertisement image selected from an authenticating category of advertisement images; and at least one advertisement image selected from a non-authenticating category of advertisement images.

5. The method of claim 4 further comprising presenting the dynamic graphical arrangement of advertisement images to a user.

6. The method of claim 5 further comprising receiving as input from the user the series of one or more access codes corresponding to the advertisement image from the authenticating category of advertisement images.

7. The method of claim 1 further comprising transmitting integrated advertisement information back to the advertising service company.

8. A method for advertising through a security authentication system, the method comprising:
receiving a plurality of advertisement images from an advertising service company;
integrating the plurality of advertisement images in a security authentication and
advertising system which will generate a dynamic graphical grid of the advertisement images; and
transmitting advertisement information back to the advertising service company.

9. The method of claim 8 further comprising receiving and logging advertisement activity.

10. The method of claim 8 further comprising presenting the dynamic graphical grid of advertisement images to a user.

11. A method of receiving compensation for a security system for protecting content distributed over a computer network comprising:
selling security authentication and advertising services to an advertising service company;
receiving a plurality of advertisement images from the advertising service company; and
integrating the plurality of advertisement images in a security authentication and advertising system which will display advertisement images.

12. A system for advertising through a security authentication system comprising:
an advertising service company; and
a security authentication and advertising system which:
receives a plurality of advertisement images from the advertising service company;
integrates the plurality of advertisement images in the security authentication and advertising system; and
transmits advertisement information back to the advertising service company.

13. The system for advertising through a security authentication system of claim 12 wherein the security authentication and advertising system integrates the plurality of advertisement images by creating a dynamic graphical arrangement of the advertisement images with: at least one advertisement image selected from an authenticating category of advertisement images; and at least one advertisement image selected from a non-authenticating category of advertisement images.

14. The system for advertising through a security authentication system of claim 12 wherein the dynamic graphical arrangement of the advertisement images is a dynamic graphical grid.

15. A computer system having a computer readable medium that stores a computer program with machine readable instructions for carrying out the method for advertising through a security authentication system comprising:
computer code that enables the receipt of a plurality of advertisement images from an advertising service company; and
computer code that integrates the plurality of advertisement images into a security authentication system having a dynamic graphical arrangement of advertisement images.
